(19) United States
(12) Patent Application Publication
(10) Pub. No.: US 2009/0077344 A1
(43) Pub. Date: Mar. 19, 2009

(54) Method for bus testing and addressing in mass memory components

(75) Inventors: Kimmo Mylly, Ylojarvi (FI); Matti Floman, Kangasala (FI); Marko Ahvenainen, Ruutana (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 12/231,329

(22) Filed: Aug. 28, 2008

Related U.S. Application Data
(60) Provisional application No. 60/966,756, filed on Aug. 28, 2007.

(51) Int. Cl. G06F 12/00

(52) U.S. Cl. 711/211; 711/200; 711/E12.001

(57) ABSTRACT

A method and apparatus for addressing a plurality of mass memory components coupled to a host device. The memory components can be arranged in a chain or in a ring configuration. In a ring, each memory component receives a bit pattern from the preceding stage and sends a bit pattern to the next stage in consecutive clock periods. Based on the received bit pattern, a recipient component knows the bus width between itself and the sending component. In a chain, each memory component also sends the received bit pattern back to the preceding stage. The memory component can generate its own address by counting clock periods. Alternatively, a recipient component changes its received bit pattern before sending the bit pattern to the next stage. As such, the recipient component knows its address based on the received bit pattern.

### CROSS REFERENCE TO RELATED APPLICATIONS

This application claims benefit to U.S. Provisional Patent Application No. 60/966,756 filed Aug. 28, 2007.

### FIELD OF THE INVENTION

The present invention relates generally to mass memory devices and, more particularly, to a plurality of mass memory devices coupled to a host device.

### BACKGROUND OF THE INVENTION

When a plurality of mass memory components (either embedded or removable) are connected into a physical communication bus in series, addressing those memory components is an important task. Furthermore, it is also important to test the individual memory components to know the working bus width in each of the memory components in the connection.

### SUMMARY OF THE INVENTION

The present invention provides a method and an apparatus for addressing a plurality of mass memory components coupled to a host device. The invention enables addressing of plurality of mass memory components connected into same communication bus without requiring more pins/signals from main ASIC and still enabling fast power up/initialization of the bus/component. Special types of IO cells, like the combined open drain/push pull, are neither needed.

In the method and apparatus for mass memory component addressing, according to the present invention, the memory component does not have a predefined address. Instead, the address is formed during initialization, and at the same time, the working bus width of each mass memory component can be checked.

The first aspect of the present invention is a method of addressing a plurality of mass memory components coupled to a host device in a series in a plurality of consecutive stages. The method comprises:

receiving a bit pattern in one of said plurality of mass memory components from a preceding stage; and

sending a further bit pattern from said one memory component to a following stage in the series, wherein said receiving and said sending are carried out at consecutive clock periods.

The coupling can be carried out in a chain configuration or in a ring configuration. In the chain configuration, the method further comprises returning the bit pattern received in said one memory component back to the preceding stage. In the ring configuration, the plurality of mass memory components includes a first memory component and a last memory component in the series, the first memory component coupled to the host device for receiving a first bit pattern from the host device, and the last memory component coupled to the host device for sending a last bit pattern to the host device.

According to one embodiment of the present invention, the plurality of mass memory components includes a first memory component followed by a second memory component in the series, the first memory component configured to receive the bit pattern from the host device and to send the further bit pattern to the second memory component.

According to various embodiments of the present invention, the first memory component is coupled to the host device via a scalable set of bus lines for obtaining the bit pattern from the host device. Likewise, the bus lines between two adjacent mass memory components in the series are also scalable.

According to one embodiment of the present invention, said one memory component is coupled to a different one of the memory components in the preceding stage in the series via a plurality of further bus lines for receiving the bit pattern from said different memory component, said plurality of further bus lines and said plurality of bus lines having same number of bus lines.

According to another embodiment of the present invention, said one memory component is coupled to a different one of the memory components in the preceding stage in the series via a plurality of further bus lines for receiving the bit pattern from said different memory components, said plurality of further bus lines having a greater number of bus lines than said plurality of bus lines.

According to embodiments of the present invention, the bit pattern comprises a first bit followed by a second bit, said one memory component configured to obtain the first bit in a clock period and to obtain the second bit in a subsequent clock period.

According to one embodiment of the present invention, said plurality of mass memory components include a first memory component followed by one or more other memory components in the series, and the first memory component is configured to obtain the first bit in a first clock period and each of said other memory components is configured to obtain the first bit in a different clock period, and wherein each of said plurality of mass memory components comprise an address indicating a different one of the consecutive stages in the series, and wherein said different clock period is indicative of the address.

According to another embodiment of the present invention, the further bit pattern is different from the bit pattern, and wherein the bit pattern in said receiving is changed to the further bit pattern by a predetermined rule known to each memory component in the series and to the host, wherein each of said plurality of mass memory components comprise an address indicating a different one of the consecutive stages in the series, and wherein the bit pattern in said receiving is indicative of the address.

In the chain configuration, said one memory component is coupled to the preceding stage via a first number of bus lines for receiving the bit pattern, and said one memory component is further coupled to the preceding stage via a second number of different bus lines for returning the bit pattern, wherein the first number is equal to the second number, wherein the first number of bus lines and the second number of bus lines are scalable. In the chain configuration, said receiving is carried out at a clock period, and said sending and returning are carried out in a next clock period.

According to various embodiments of the present invention, each of the memory components is configured to determine the bus width from the bit pattern from its preceding state and to provide information indicative of the bus width to the host device.

According to various embodiments of the present invention, each memory component is configured to provide information indicative of its address to the host device.

The second aspect of the present invention is an apparatus for addressing a plurality of mass memory components coupled to a host device, the apparatus comprising:

a host device, and

a plurality of bus lines configured to couple the host device with a plurality of mass memory components in a series in a plurality of consecutive stages, such that one of the mass memory components is configured to receive a bit pattern from a preceding state; and sending a further bit pattern to a following stage in the series.

According to one embodiment of the present invention, the bit pattern comprises a first bit followed by a second bit, said one memory component configured to obtain the first bit in a clock period and to obtain the second bit in a subsequent clock period, and the plurality of mass memory components include a first memory component followed by one or more other memory components in the series, and the first memory component is configured to obtain the first bit in a first clock period and each of said other memory components is configured to obtain the first bit in a different clock period, and wherein each of said plurality of mass memory components comprise an address indicating a different one of the consecutive stages in the series, and wherein said different clock period is indicative of the address.

According to another embodiment of the present invention, the further bit pattern is different from the bit pattern, and wherein the bit pattern in said receiving is changed to the further bit pattern by a predetermined rule known to each memory component in the series and to the host, and each of said plurality of mass memory components comprise an address indicating a different one of the consecutive stages in the series, and wherein the bit pattern in said receiving is indicative of the address.

In one embodiment of the present invention, the plurality of mass memory components includes a first memory component and a last memory component in the series, the first memory component coupled to the host device for obtaining a first bit pattern from the host device in said receiving, and the last memory component coupled to the host device for providing a last bit pattern to the host device in said sending.

In a different embodiment of the present invention, each memory component is configured to return the received bit pattern back to the preceding stage.

In various embodiment of the present invention, the sending, forwarding or returning of a bit pattern or a further bit pattern from a memory component to an adjacent stage takes place at one or more clock signal changes after receiving the bit pattern from the preceding stage.

The present invention will become apparent upon reading the description in conjunction with FIGS. 1 to 4.

### BRIEF DESCRIPTION OF THE DRAWINGS

FIG. 1 shows a plurality of mass memory components connected to a host in a chain through two sets of unidirectional bus lines.

FIG. 2 shows three mass memory components connected to a host in a chain wherein the bus width between the last component and its preceding component is smaller than the bus width in other connections.

FIG. 3 shows a plurality of mass memory components connected to a host in a ring.

FIG. 4 shows a table listing the information known to the components and the host at a clock period.

### DETAILED DESCRIPTION OF THE INVENTION

In prior art, the addressing procedures are carried out by one of the following ways:
Separate chip select for each chip/memory component;
Separate bus (serial peripheral interface or SPI) or multiplexed bus (secure digital or SD card); and
Allocation of device address electrically in specific open drain mode, such as in a MultiMedia card or MMC.

According to the present invention, it would not be necessary to have a predefined address for a mass memory component in a chain or a ring of mass memory components coupled to a host device. The address of each mass memory component in such a chain or a ring is formed during initialization in association with the checking of the working bus width of the mass memory components.

### Bus Connections

According to the present invention, the memory components, when coupled to a host device, can be arranged in a chain or a ring. When the memory components or devices are connected to a host device in a chain, the memory device at the end of the chain is allowed to be removed from that chain. Also, it is possible to add one or more memory devices at the end of the chain. In the ring configuration, the removal of a memory device from the ring and the insertion of a memory device to the ring would be complicated.

In the mass memory components or devices to be connected, the bus lines are unidirectional. The bus lines can be used either for receiving signals or data to the device or for sending signals or data from the device. Thus, any one device should have incoming bus lines and outgoing bus lines separately.

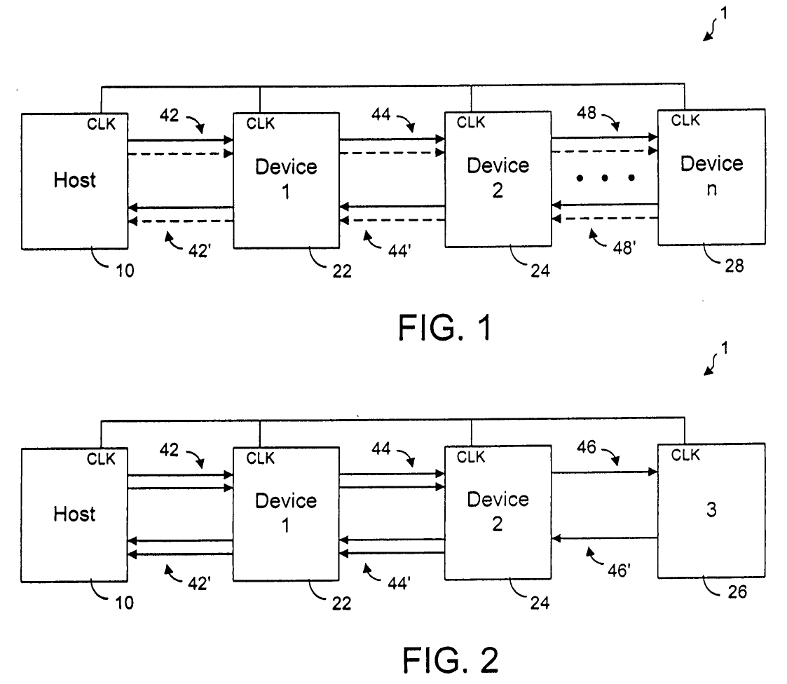

The connection of mass memory components or devices in a chain configuration is shown in FIG. 1. In the chain 1 for connection with a host device 10 as shown in FIG. 1, each of the devices or components, except for the last one in the chain, will have two sets of incoming bus lines and two sets of outgoing bus lines. For example, Device 1 or component 22 has a set of incoming bus lines 42 and a set of outgoing bus lines 42′ connected to the host device 10. Device 1 also has a set of incoming bus lines 44′ and a set of outgoing bus lines 44 connected to Device 2, or component 24. Likewise, Device 2 has a set of incoming bus lines 48′ and a set of outgoing bus lines 48 connected to the next component or device in the chain. The bus lines 44 connected to Device 1 also serve as the incoming bus lines for Device 2 and the bus lines 44′ connected to Device 1 also serve as the outgoing bus lines for Device 2. Component 28 or Device n is the last device in the chain 1.

The number of bus lines in a set can be adjusted as the bus connection is scalable. Furthermore, the arrangement of bus lines on two sides of a memory device within a chain may be non-symmetrical. For example, the number of bus lines in the sets 44, 44′ on Device 2 is greater on the host device side than the number of bus lines in the sets 46, 46′ on the chain-end side. The chain as depicted in FIG. 1 ends at Device n or component 28. The non-symmetrical bus connection is shown in FIG. 2.

It should be noted that the host device can form one or more chains with other memory devices, depending on the number of bus lines available in the host device and the number of bus lines used in the chains.

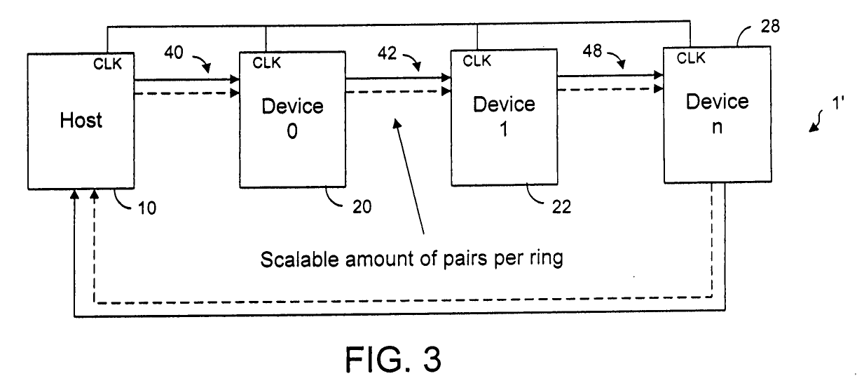

The connection of mass memory components or devices in a ring configuration is shown in FIG. 3. In a ring 1′ for connection with the host device 10 as shown in FIG. 3, each of the devices in the ring has one set of incoming bus lines and one set of outgoing bus lines. For example, Device 0 or component 20 has a set of incoming bus lines 40 connected to the host device 10 and a set of outgoing bus lines 42 connected to Device 1. Likewise, Device 1 or component 22 has a set of outgoing bus lines 48 connected to the next component or device in the ring 1′. The bus lines 42 connected to Device 0 also serve as the incoming bus lines for Device 1. The number of bus lines in a set can be adjusted as the bus connection is scalable.

It should be noted that a clock signal CLK is provided to all the devices or components in the chain 1 (see FIG. 1) or the ring 1′.

### Addressing and Testing Procedures

### (a) For the Chain

After power up the host will send a bit pattern, which consists, for example, of a start bit “s”, and a stop bit “S”. The bit pattern can be as simple as “01” with the stop bit following the start bit. A more complicated pattern can be used for special situations, but this pattern is enough for normal usage.

After a predefined waiting time period to allow the operation of the devices to become stable and the clock (CLK) in the chain also to become stable, the host device can start sending out the first bit of the pattern.

According to one embodiment of the present invention, the bus testing procedure starts at the same time with the clock and each device starts counting the clock whenever it gets the clock pulses. Once the sending of the bit pattern starts at the starting clock (clock period #1, for example), each device starts to count the clock. In case of multiple bus lines, each bit of the pattern is simultaneously sent in all bus lines. That is, in case of a simple bit pattern with the start bit and the stop bit, the start bit is first sent in all lines and at the next clock period the stop bit is sent in all bus lines.

Once the first device in the chain after the host (Device 1) receives the start bit, it forwards the start bit to the next device in the chain (Device 2) and, at the same time, sends the start bit back to host. This will take place on the next clock (clock period #2). Once the first device receives the stop bit, it knows the working bus width between the host and itself.

Once the second device in the chain after the host (Device 2) receives the start bit at clock period #2, it sends the start bit to the next device in the chain (Device 3) and, at the same time, sends the start bit back to the first device (Device 1). This will take place on the following clock (clock period #3).

All the remaining devices in the chain, except for the last one in the chain (Device n), follow the same manner in sending the start bit to the next one in the chain and, at the same time, sending the start bit back to the preceding one in the chain. When the last device in the chain (Device n) receives the start bit, it can only send it back to the preceding one successfully. However, the last device may also send the bit pattern forward in the chain in addition to sending it back to the preceding device although there are no more devices in the chain. The last device does not necessarily know it is a last device in the chain.

In the procedure as described, a Device m in the chain receives the start bit at clock period #m and sends out the start bit at clock period #(m+1).

Once any device receives the start bit, it uses a clock calculator value for getting its own device address or ID (first device=1 and second devices=2 and so on). At the end of the chain device, the last device (Device n) does not receive any returning bit pattern and, therefore, it knows that it is the last device.

The address can be obtained in many other ways. According to another embodiment of the present invention, each device in the chain changes the test pattern in a predetermined way and sends the changed pattern to the next device.

Let us use a pattern such as “s0000S” to demonstrate the start of the addressing and testing procedure, for example. The start bit “s” is sent from the host to Device 1 in all bus lines 42 at clock period #1; the four “0” bits are separately sent from the host to Device 1 in all bus lines 42 at clock period #2, #3, #4 and #5; and the stop bit “S” is sent from the host to Device 1 in all bus lines 42 at clock period #6. As Device 1 receives the stop bit “S” at clock period #6, Device 1 knows the bus width between the host device and itself, and also knows the entire received pattern being “s0000S”.

Instead of forwarding the received pattern “s0000S” to the next device in the chain and to the host, Device 1 can change the pattern to “s0001” and send the changed pattern to Device 2. Device 1 can use the pattern “s0001” as its address and send the pattern “s0001” back to the host at clock period #7. Likewise, Device 2 sent the pattern “s0002S” to Device 3 and Device 1. Device 2 also uses “s0002S” as its address.

The last device (Device n) receives the entire pattern “s000XS” (X=n−1) at clock period #(n+5). Device n may send out the pattern “s000nS” to its preceding device and to the non-existing next device at clock period #(n+6). Since the next device is non-existing, Device n does not receive a pattern “s000YS” (Y=n+1) at clock period #(n+7). Device n then knows it is the last device in the chain.

At this point, Device n can notify the host device 10 that the end of the chain has been reached, indicating that the testing procedure has been completed.

It is possible to arrange for Device n to send a “terminal” bit, such as “S”, to its preceding device at clock period #(n+8), for example. When a device within the chain receives the bit “S” from its next device a second time, it is also arranged to send that bit to its preceding device for it knows that the bit is sent from the last device in the chain. When the host receives the bit “S” a second time from Device 1, it knows that the testing is completed. The host would know the number of memory devices in the chain by examining the clock period at which it receives the terminal bit “S”. For example, if there are 4 memory devices in the chain, the last device (Device 4) receives the entire bit pattern “s0003S” at clock period #9. The terminal bit “S” is sent out by Device 4 and receives by Device 3 at clock period #12. Device 3 sends the terminal bit to Device 2 at clock period #13 and Device 2 sends the terminal bit to Device 1 at clock period #14. At clock period #15, the host receives this terminal bit “S”. Since the host receives the stop bit “S” from Device 1 at clock period #7, it can determine the number of memory devices counting the difference between the two clock periods divided by 2 or (15-7)/2.

After the bus testing procedure is finished, each device knows the bus width that can be used for communicating with the adjacent devices in the chain. This information is read from the bit pattern on the bus returned by the next device in the chain. For example, the one step forward bus width of Device 1 is the widths of the incoming and going bus lines between Device 1 and Device 2. It should be noted that the bus width one step backward in the chain can also be known. In the chain as shown in FIG. 2, the one step forward bus width for Device 2 is 1, while the one step forward bus width for Device 3 is 0.

Each device also knows its own device ID (address or position in the chain). This information (ID, bus-widths forward) is then sent to host via information packet (automatically or as a response to a request from the host) depending on protocol specific structure. Once the host receives all information packets (last device could also indicate that it is the last one or there could be specific timings for host to figure out that no more information packets are coming), it may then send to each of the devices a packet which has the device ID and the working bus widths forward and backward.

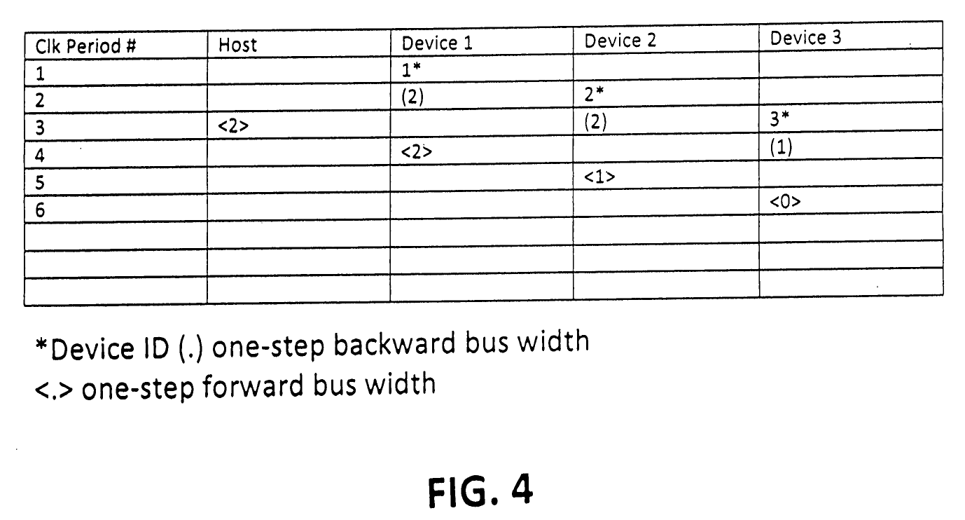

FIG. 4 shows the information known at each clock period for the chain as shown in FIG. 2. At clock period #1 Device 1 receives a start bit, and knows its device ID which in this case is 1 (shown with *). The test pattern, in this example, includes only a start bit followed by a stop bit.

At clock period #2 Device 2 receives the start bit sent by Device 1 and knows its device ID=2 (shown with *). At clock period #2 Device 1 also sends the start bit back to the host, and receives a stop bit sent by the host. After receiving the stop bit, Device 1 knows the bus width between the host and itself, i.e. one step backward, as indicated with a number in parenthesis. Thus, in FIG. 4, the number in parenthesis is the width of the bus width from which a device received a bit pattern from the preceding stage. In this example, the number in parenthesis under Device 1 is 2, which is the width of the bus 42 from which Device 1 receives from the host.

At clock period #3, the host receives a stop bit sent back by Device 1 (working bus width one step forward) and thus knows the bus width that is used to communicate with Device 1. In this example the width of the bus 42′ between the host and Device 1 is 2. The width of the working bus with one step forward is shown in brackets. At the same clock period Device 2 sends a start bit to Device 3 and back to Device 1. Device 2 receives a stop bit sent by Device 1 (the number in parenthesis indicates the width of the bus 44 between Device 1 and Device 2). Device 3 receives the start bit sent by Device 2, and thus knows its device ID=3 (shown with *).

At clock period #4 Device 1 receives a stop bit sent back by Device 2 and knows usable bus width one step forward. In this example, the width of the bus 44′ between Device 1 and Device 2 is also 2, as shown in brackets. At the same clock period Device 3 sends the start bit back to Device 2 and Device 3 sends the start bit forward in the chain. Also, Device 2 sends the stop bit to Device 3. From the stop bit Device 3 knows the width of the bus 46 is 1 as shown in parenthesis.

At clock period #5 Device 2 receives the stop bit sent back by Device 3 and knows usable bus width between Device 2 and Device 3. In this example, the width of the bus 46′ that can be used between Device 2 and Device 3 is 1. Device 3 may also send the stop bit forward in the chain.

Finally, at clock period #6, Device 3 knows a working bus width one step forward, which in this case is 0 as Device 3 is the last device in the chain.

It should be noted that FIG. 4 shows only a non-limiting example of information known at each clock period. For example clock periods required to detect bus width may be different than described above. For instance, as both the start bit and the stop bit (in case of only two bit patterns) are sent and received in a similar manner, it is possible to detect the bus width based on the start bit instead of the stop bit sent back by the next device.

### (b) For the Ring

One way to implement the ring bus test procedure is to follow the chain method, with the exception that the bit pattern is not sent back to the preceding device. In this case, the bit pattern loops through the whole ring until the host receives it from the last one in the ring. An example of the ring configuration is shown in FIG. 3.

Once the sending of the bit pattern starts at the starting clock (clock period #1), each device starts to count the clock (for generating an address ID, according to one embodiment of the present invention). In case of multiple bus lines, each bit of the bit pattern is sent in all lines. For example, the host sends the start bit in 2 bus lines at clock period #1 and the stop bit in all lines at the next clock period. If all devices in the ring have 2 bus lines, the host will finally receive the start and stop bits in 2 lines. If, however, one device in the ring has only one bus line, it can receive and send a bit only in one line. Therefore, the host finally receives the start and stop bit in one line (instead of two lines), and thus knows that the maximum number of working pins in the ring is 1.

From the amount of bits in the returning pattern, the host knows the maximum number of working pins in the ring. After this and in a similar manner, the host informs each of the devices in the ring of the maximum working bus width and the device ID.

It is also possible to collect working bus width in the way that devices inform the host of their IDs and the number of working pins they have between each one of them and the previous device. This later method would allow different bus widths within the ring.

In case a removable device is connected in the ring, it will inform this to the host, for example, using interrupt. The host may then completely re-initialize the device ring. This may cause some additional problems if there are some activities going on since the removable device may change the data widths between the devices to which it was connected.

According to another embodiment of the present invention, whenever a device receives a bit pattern from a preceding stage, it changes the bit pattern in a predetermined way, such as changing “s0003S” to “s0004S”. The changed bit pattern will be sent to the next stage. The address or the device position in the ring can be determined from the received bit pattern or the changed bit pattern.

In sum, the present invention provides a method and apparatus for addressing a plurality of mass memory components coupled to a host device. The memory components can be arranged in a chain or in a ring configuration. In a ring, each memory component receives a bit pattern from the preceding stage and sends a bit pattern to the next stage in consecutive clock periods. Based on the received bit pattern, a recipient component knows the bus width between itself and the sending component. In a chain, each memory component also sends the received bit pattern back to the preceding stage. The memory component can generate its own address by counting clock periods. Alternatively, a recipient component changes its received bit pattern before sending the bit pattern to the next stage. As such, the recipient component knows its address based on the received bit pattern.

It should be noted that the sending, forwarding or returning the bit pattern to an adjacent stage (preceding or following stage) can be carried out in a next clock cycle or period after a memory component receives a bit pattern from a preceding stage. It is also possible that the sending, forwarding or returning of the bit pattern to the adjacent stage takes place more than one clock cycle or period. It is also possible that the sending, forwarding or returning of the bit pattern to the adjacent stage takes place at a different edge of a clock signal, for example. In other words, the conveying of a bit pattern can take place at one or more clock signal changes.

Thus, although the present invention has been described with respect to one or more embodiments thereof, it will be understood by those skilled in the art that the foregoing and various other changes, omissions and deviations in the form and detail thereof may be made without departing from the scope of this invention.

1. A method of addressing a plurality of mass memory components coupled to a host device in a series in a plurality of consecutive stages, comprising:
receiving a bit pattern in one of said plurality of mass memory components from a preceding stage; and
sending a further bit pattern from said one memory component to a following stage in the series.

2. The method of claim 1, wherein said plurality of mass memory components comprises a first memory component followed by a second memory component in the series, the first memory component configured to obtain the bit pattern from the host device in said receiving and to provide the further bit pattern to the second memory component in the series in said sending.

3. The method of claim 2, wherein the bit pattern comprises a plurality of bits and the first memory component is coupled to the host device via a plurality of bus lines, the host device configured to provide each of said plurality of bits in the bit pattern to the first memory device in all of said plurality of bus lines.

4. The method of claim 2, wherein the first memory component is coupled to the host device via a scalable set of bus lines for obtaining the bit pattern from the host device.

5. The method of claim 1, wherein the further bit pattern comprises a plurality of bits and said one memory component is coupled to another one of the memory components in the following stage in the series via a plurality of bus lines, said one memory component configured to provide each of said plurality of bits in the further bit pattern to said another memory component in all of said plurality of bus lines.

6. The method of claim 5, wherein said one memory component is coupled to a different one of the memory components in the preceding stage in the series via a plurality of further bus lines for receiving the bit pattern from said different memory component, said plurality of further bus lines and said plurality of bus lines having same number of bus lines.

7. The method of claim 5, wherein said one memory component is coupled to a different one of the memory components in the preceding stage in the series via a plurality of further bus lines for receiving the bit pattern from said different memory component, said plurality of further bus lines having a smaller number of bus lines than said plurality of bus lines.

8. The method of claim 1, wherein said receiving and said sending are carried out at consecutive clock periods such that the sending is carried out at one or more clock signal changes after said receiving.

9. The method of claim 1, wherein the bit pattern comprises a first bit followed by a second bit, said one memory component configured to obtain the first bit in a clock period and to obtain the second bit in a subsequent clock period.

10. The method of claim 9, wherein said plurality of mass memory components comprises a first memory component followed by one or more other memory components in the series, and the first memory component is configured to obtain the first bit in a first clock period and each of said other memory components is configured to obtain the first bit in a different clock period, and wherein each of said plurality of mass memory components comprises an address indicating a different one of the consecutive stages in the series, and wherein said different clock period is indicative of the address.

11. The method of claim 1, wherein the further bit pattern is different from the bit pattern, and wherein the bit pattern in said receiving is changed to the further bit pattern by a predetermined rule known to each memory component in the series and to the host.

12. The method of claim 11, wherein each of said plurality of mass memory components comprises an address indicating a different one of the consecutive stages in the series, and wherein the bit pattern in said receiving is indicative of the address.

13. The method of claim 1, wherein said plurality of mass memory components comprises a first memory component and a last memory component in the series, the first memory component coupled to the host device for obtaining a first bit pattern from the host device in said receiving, and the last memory component coupled to the host device for providing a last bit pattern to the host device in said sending.

14. The method of claim 1, further comprising:
returning the bit pattern received in said one memory component back to the preceding stage.

15. The method of claim 14, wherein said one memory component is coupled to the preceding stage via a first number of bus lines for receiving the bit pattern, and said one memory components is further coupled to the preceding stage via a second number of different bus lines for returning the bit pattern, wherein the first number is equal to the second number.

16. The method of claim 15, wherein the first number of bus lines and the second number of bus lines are scalable.

17. The method of claim 14, wherein said receiving is carried out at a clock period, and
said sending and returning are carried out at one or more clock signal changes subsequent to said receiving.

18. The method of claim 3, further comprising:
determining a width of said plurality of bus lines based on the bit pattern.

19. The method of claim 5, further comprising:
determining a width of said plurality of bus lines based on the bit pattern; and
providing information indicative of the width to the host device.

20. The method of claim 10, further comprising:
providing information indicative of the address to the host device.

21. The method of claim 12, further comprising:
providing information indicative of the address to the host device.

22. An apparatus, comprising:
a host device, and
a plurality of bus lines configured to couple the host device with a plurality of mass memory components in a series in a plurality of consecutive stages, such that each one of the mass memory components is configured to receive a bit pattern from a preceding state; and sending a further bit pattern to a following stage in the series.

23. The apparatus of claim 22, wherein said plurality of mass memory components comprises a first memory component followed by a second memory component in the series, the first memory component configured to obtain the bit pattern from the host device in said receiving and to provide the further bit pattern to the second memory component in the series.

24. The apparatus of claim 23, wherein the bit pattern comprises a plurality of bits and the first memory component is coupled to the host device via a plurality of bus lines, the host device configured to provide each of said plurality of bits in the bit pattern to the first memory device in all of said plurality of bus lines.

25. The apparatus of claim 24, wherein the further bit pattern comprises a plurality of bits and said mass memory components comprise adjacent memory components coupled via a plurality of bus lines, the adjacent memory components comprising a first memory component followed by a second memory component, wherein the first memory component is configured to provide each of said plurality of bits in the further bit pattern to the second memory component in all of said plurality of bus lines.

26. The apparatus of claim 25, wherein said first memory component is coupled to a different one of the memory components in the preceding stage in the series via a plurality of further bus lines for receiving the bit pattern from said different memory component, said plurality of further bus lines and said plurality of bus lines having same number of bus lines.

27. The apparatus of claim 25, wherein the first memory component is coupled to a different one of the memory components in the preceding stage in the series via a plurality of further bus lines for receiving the bit pattern from said different memory component, said plurality of further bus lines having a greater number of bus lines than said plurality of bus lines.

28. The apparatus of claim 22, wherein the bit pattern comprises a first bit followed by a second bit, said each one memory component configured to obtain the first bit in a clock period and to obtain the second bit in a subsequent clock period.

29. The apparatus of claim 28, wherein said plurality of mass memory components comprises a first memory component followed by one or more other memory components in the series, and the first memory component is configured to obtain the first bit in a first clock period and each of said other memory components is configured to obtain the first bit in a different clock period, and wherein each of said plurality of mass memory components comprises an address indicating a different one of the consecutive stages in the series, and wherein said different clock period is indicative of the address.

30. The apparatus of claim 22, wherein the further bit pattern is different from the bit pattern, and wherein the bit pattern in said receiving is changed to the further bit pattern by a predetermined rule known to each memory component in the series and to the host.

31. The method of claim 30, wherein each of said plurality of mass memory components comprises an address indicating a different one of the consecutive stages in the series, and wherein the bit pattern in said receiving is indicative of the address.

32. The apparatus of claim 22, wherein said plurality of mass memory components comprises a first memory component and a last memory component in the series, the first memory component coupled to the host device for obtaining a first bit pattern from the host device in said receiving, and the last memory component coupled to the host device for providing a last bit pattern to the host device.

33. The apparatus of claim 22, wherein said one memory component is configured to return the received bit pattern from the preceding stage back to the preceding stage.

34. The apparatus of claim 29, wherein each of said plurality of mass memory components is configured to provide the address to the host device.

35. The apparatus of claim 31, wherein each of said plurality of mass memory components is configured to provide the address to the host device.

36. The apparatus of claim 25, wherein the second memory component is configured to determine a width of the bus lines based on the further bit pattern, and to provide information indicative of the width to the host device.
